(19) United States
(12) Patent Application Publication
(10) Pub. No.: US 2019/0318836 A1
(43) Pub. Date: Oct. 17, 2019

(54) SYSTEM FOR GENERATING AND MAINTAINING A SOLID STRUCTURE

(71) Applicant: Michael Greene, Brooklyn, NY (US)

(72) Inventor: Michael Greene, Brooklyn, NY (US)

(21) Appl. No.: 15/952,042

(22) Filed: Apr. 12, 2018

(51) Int. Cl. G21C 21/00; G21C 13/08; G21C 9/02

(52) U.S. Cl. CPC G21C 21/00; F25C 5/14; G21C 9/02; G21C 13/08

(57) ABSTRACT

A method and system for generating and maintaining a solid structure is provided. The system includes a frame composed of an interconnected network of pipes configured for transporting liquid, the frame having a substantially spherical shape, a plurality of nozzles uniformly distributed along the pipes, wherein the plurality of nozzles are configured for dispensing liquid, a repository that holds a liquid composed of water and at least one additive, a refrigeration unit configured for refrigerating the liquid from the repository to at least a freezing temperature, and a pump for pumping the liquid from the refrigeration unit through the pipes and out of the nozzles, wherein the system is configured to dispense the liquid at said freezing temperature so as to freeze upon egress and create a solid structure surrounding the pipes. The system may also return melted liquid from the solid structure to the repository.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the construction and maintenance of solid structures and, more specifically, to processes for improving the efficiency and strength thereof.

### BACKGROUND

There is, and has been, a need to make the process of construction and maintenance of structures more efficient and cost effective. Take concrete, for example, which is a widely used structural and civil engineering material with applications ranging from small objects like fence posts to roads, dams, and other massive structures. Concrete has a variety of drawbacks associated with it. For example, although concrete by itself is very strong in compression, it has limited strength in tension and bending. Furthermore, concrete is heavy and bulky and requires that it is hauled in large amounts to the location of the structure being built or maintained. This can be costly and time consuming.

Furthermore, a problem exists in certain building construction situations in that it is difficult to obtain and use the heavy equipment which is necessary to lift and place heavy concrete items, such as concrete slabs, on their supports. While it is possible to avoid precast structures by casting the slab in place, another problem arises in that forms made of wood or other material must be built in place and the retrieval of the forming structures is very difficult. Moreover, the cost of forming concrete on the site is expensive. Nonetheless, forming, pouring and finishing a concrete slab takes special skills and equipment, thus resulting in costs that can be prohibitive unless the building structure is very large so as to afford repetitive forming.

One known solution to the problems outlined above involve the use of pykrete. Pykrete is a frozen composite material composed mainly of water and a hardening agent, such as sawdust or some other form of wood pulp (such as paper). Pykrete features certain beneficial properties, including a relatively slow melting rate due to its low thermal conductivity, as well as a vastly improved strength and toughness compared to ice. These physical properties can make the material comparable to concrete, as long as the material is kept frozen. Further, pykrete can be repaired and maintained using seawater as a raw material. The pykrete mixture can be molded into any shape and frozen, resulting in a tough and durable substance, as long as it is kept at or below freezing temperature. The use of pykrete, however, has drawbacks of its own. There are no current efficient solutions for constructing a pykrete structure efficiently and in a small amount of time, and there are no current solutions for having a permanent maintenance system for maintaining said structure.

Therefore, a need exists for improvements over the prior art, and more particularly for improved methods and systems for building and maintaining structures.

### SUMMARY

A method and system for generating and maintaining a solid structure is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the system for generating and maintaining a solid structure includes a frame composed of an interconnected network of pipes configured for transporting liquid, the frame having a substantially spherical shape, a plurality of nozzles uniformly distributed along the pipes, wherein the plurality of nozzles are configured for dispensing liquid, a repository that holds a liquid composed of water and at least one additive, a refrigeration unit configured for refrigerating the liquid from the repository to at least a freezing temperature, and a pump for pumping the liquid from the refrigeration unit through the pipes and out of the nozzles, wherein the system is configured to dispense the liquid at said freezing temperature so as to freeze upon egress and create a solid structure surrounding the pipes. In an additional embodiment, the system also includes a collection system that collects liquid that has melted from the solid structure, and returns said liquid to the repository.

### BRIEF DESCRIPTION OF THE DRAWINGS

The accompanying drawings, which are incorporated in and constitute a part of this disclosure, illustrate various example embodiments. In the drawings:

FIG. 1A is a diagram of a method and system for using pykrete to build and maintain a structure, prior to activation of the system, according to an example embodiment;

FIG. 1B is a diagram of the method and system for using pykrete to build and maintain a structure, after activation of the system, according to an example embodiment;

FIG. 2 is a block diagram of the main components of the method and system for using pykrete to build and maintain a structure, according to an example embodiment;

FIG. 3 is a cross-sectional view of one embodiment of the method and system for using pykrete to build and maintain a structure, according to an example embodiment;

FIG. 4 is a drawing of one of the main components of the method and system for using pykrete to build and maintain a structure, according to an example embodiment;

FIG. 5 is a flowchart showing the control flow of the method and system for building and maintaining a structure using pykrete, according to an example embodiment;

FIG. 6 is a block diagram of a computing device used with the example embodiments.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed subject matter improves over the prior art by providing a simple, cost-effective and efficient system and method for building and maintaining solid structures. The claimed subject matter provides for the building of solid structures using a material that is strong in compression, as well as strength in tension and bending. Furthermore, the building material (water and an additive) is not heavy or bulky and does not require that it is hauled in large amounts to the location of the structure being built or maintained, since the structure may be built on, or near a body of water. This feature reduces the time and cost involved with building solid structure. Also, the claimed subject matter does not require the use of heavy equipment, since there are no heavy components, such as concrete slabs, used in the building of the structure. Further, the claimed subject matter reduces or eliminates the necessity for forms made of wood or other material that must be built in place and later retrieved, as is often needed when forming concrete structures. Also, the claimed subject matter does not require the use of special skills or equipment, further adding to the savings in time and cost. Lastly, the claimed subject matter can be used for the housing of radioactive material in a safe and cost effective way, so as to aid in the prevention of radioactive contamination to the environment.

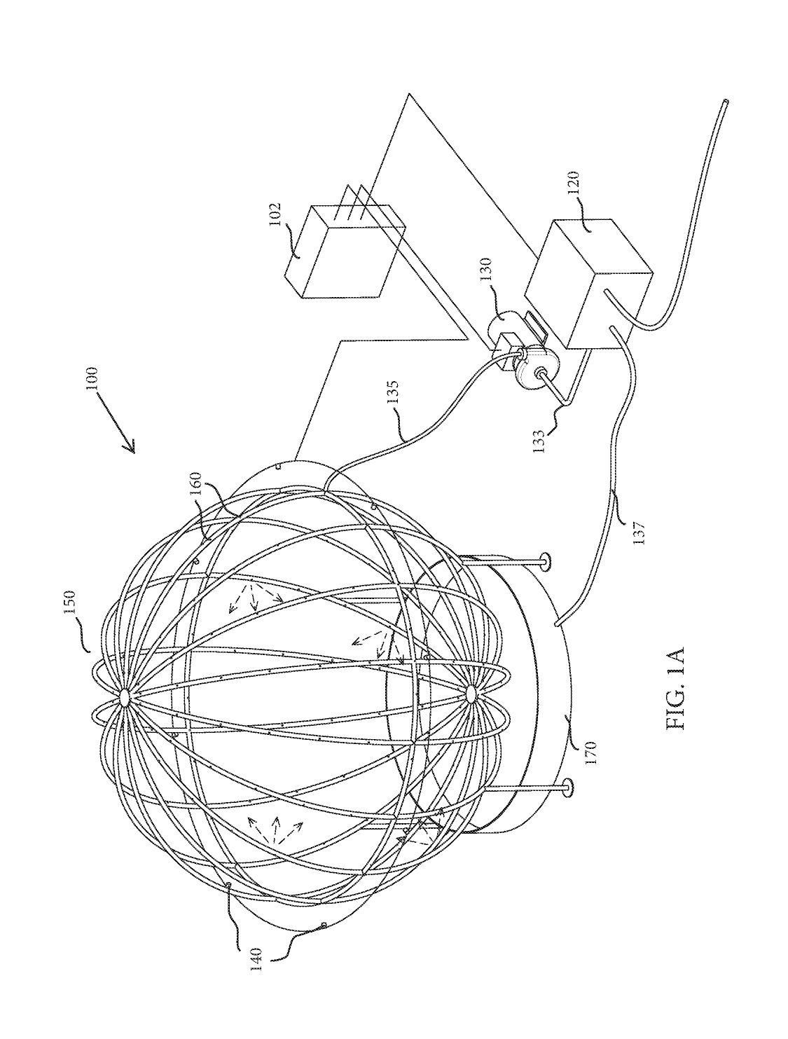

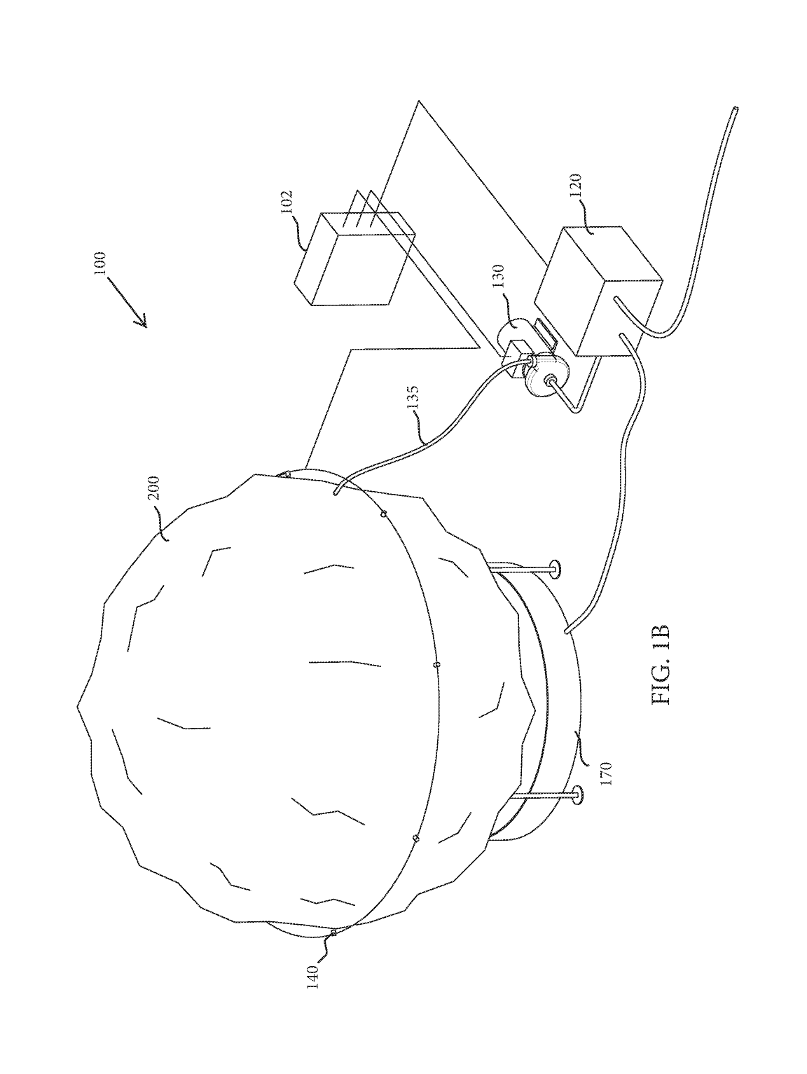

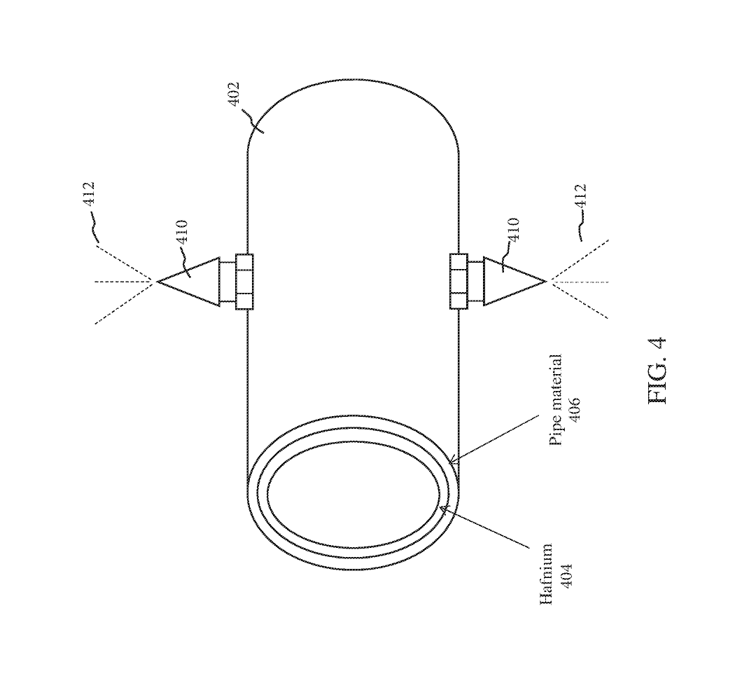

FIG. 1A is a diagram of a method and system 100 for using pykrete to build and maintain a structure, prior to activation of the system, according to an example embodiment. The term “pykrete” herein is a solid substance that is formed from freezing a mixture of water (whether fresh water, spring water, brackish water, seawater or the like) and an additive, such as wood pulp, paper or the like, which adds strength to the final product. The system 100 includes a spherical structure 150 comprised of a series of interconnected pipes that include a plurality of nozzles 160 distributed substantially uniformly along the length of the pipes. The pipes are conduits configured for transporting liquid, namely, the liquid form of pykrete, or the liquid mixture that forms pykrete (hereafter referred to as the “mixture”). The nozzles 160 are configured for dispersing the mixture which is pumped through the pipes. See FIG. 4 for a more detailed description of the nozzles 160 and the pipes.

Note that although FIG. 1 shows spherical structure 150 in a particular size, the claimed subject matter supports a spherical structure 150 of any size, including a size large enough to house nuclear material, such as an equivalent to a 10-15 story building.

The system 100 includes a refrigeration unit 120 configured for lowering the temperature of the mixture from a repository that holds the mixture. The refrigeration unit 120 may lower the temperature of the mixture to freezing temperature of the mixture, or near said freezing temperature. The repository may be one or more tanks, reservoirs, ponds, lakes, bodies of water, or the like. The system 100 also includes a pump 130, which is configured for pumping the mixture from the refrigeration unit 120 (via liquid conduit 133) into the series of pipes of the structure 150 (via liquid conduit 135), and then out of the nozzles 160.

The system 100 also includes a collection unit 170 for collecting liquid, melted mixture or liquid runoff from the spherical structure 150. The collection unit 170 is located under the spherical structure 150 and acts like a reservoir to catch any liquid that originates from above the collection unit. The pump 130 is configured for pumping the liquid in the collection unit 170 (via liquid conduit 137) back into the series of pipes of the structure 150 (via liquid conduit 135).

The system 100 may also include one or more sensors 140 for sensing various characteristics of the spherical structure 150 and the collection unit 170. The sensors 140 may be cameras, length sensors, conductance sensors, thermometers, thermal imagers, liquid level sensors, etc. Therefore, the one or more sensors 140 may be configured for sensing the following characteristics of the spherical structure 150: appearance, size, length, thickness of the walls, conductance, temperature, thermal output, level of liquid, etc.

In another embodiment, the one or more sensors 140 may also calculate current geographical position (otherwise referred to as geographical location data) of each sensor using a sub-system, an on-board processor or a connected processor. In one embodiment, the one or more sensors 140 may calculate current position using a satellite or ground based positioning system, such as a Global Positioning System (GPS) system, which is a navigation device that receives satellite or land-based signals for the purpose of determining the device's current geographical position on Earth. Generally, one or more sensors 140 calculate global navigation satellite system (GNSS) data. A GNSS or GPS receiver, and its accompanying processor, may calculate latitude, longitude and altitude information. In this document, the terms GNSS and GPS are used generally to refer to any global navigation satellite system, such as GLONASS, GALILEO, GPS, etc. In this embodiment, a radio frequency signal is received from a satellite or ground based transmitter comprising a time the signal was transmitted and a position of the transmitter. Subsequently, the one or more sensors 140 calculate current geographical location data of the device based on the signal. In another embodiment, the one or more sensors 140 calculate current geographical location using alternative services, such as control plan locating, GSM localization, dead reckoning, or any combination of the aforementioned position services. The term spatial technologies or spatial processes refers generally to any processes and systems for determining one's position using radio signals received from various sources, including satellite sources, land-based sources and the like.

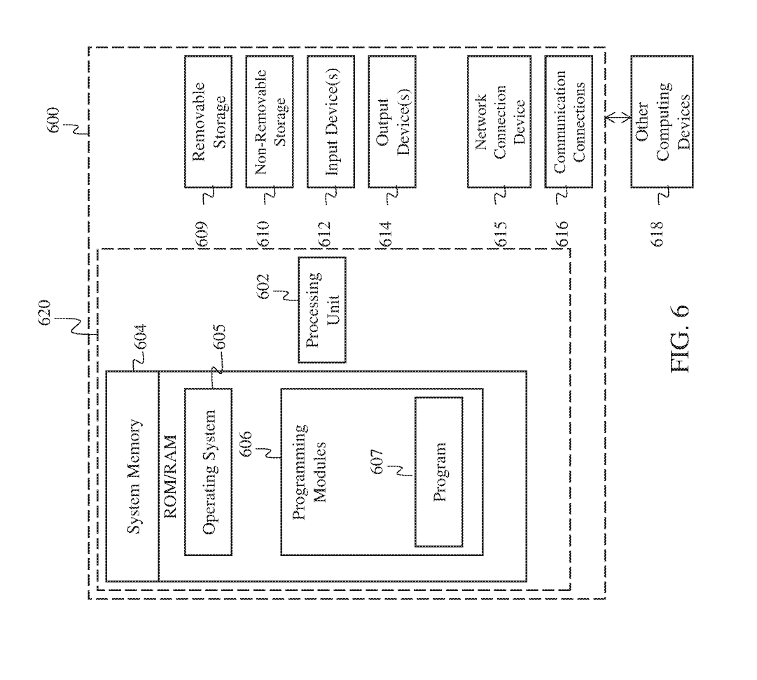

The system 100 may also comprise a computing device or system 102, which may communicate with other devices via a communications network. The server or computing device or system 102 may be communicatively coupled with a communications network, according to an example embodiment. The computing device or system 102 may comprise one or more servers, workstations, desktop computers, cellular/mobile telephones, smart phones, tablet computers, laptop computers, handheld computers, wearable computers, or the like. Device 102 may also comprise other computing devices such as remotely located servers. The computing device 102 may be connected either wirelessly or in a wired or fiber optic form to the communications network. The communications network may be a packet switched network, such as the Internet, or any local area network, wide area network, enterprise private network, cellular network, phone network, mobile communications network, or any combination of the above. Device 102 may comprise a computing device 600, described below in greater detail with respect to FIG. 6.

The computing device or system 102 is communicatively coupled with the one or more sensors 140, the pump 130, the collection unit 170 and the refrigeration unit 120. The computing device or system 102 receives data from the one or more sensors 140, the pump 130, the collection unit 170 and the refrigeration unit 120. The computing device or system 102 may, for example, receive data from the pump 130 pertaining to the capacity of the pump, the amount of liquid pumped, times of operation, malfunction data, etc. The computing device or system 102 may, for example, receive data from the refrigeration unit 120 pertaining to the capacity of the refrigeration unit, the amount of liquid refrigerated, times of operation, malfunction data, etc. The computing device or system 102 may, for example, receive data from the collection unit 170 pertaining to the level of liquid inside the collection unit. Based on the data it receives from the one or more sensors 140, the pump 130, the collection unit 170 and the refrigeration unit 120, the computing device 102 may send command data to the one or more sensors 140, the pump 130, and the refrigeration unit 120. For example, the computing device 102 may command the pump 130 and the refrigeration unit to turn on or off, and the device 120 may command the refrigeration unit to lower or raise the temperature to which it is refrigerating the mixture. The device 102 may also command the one or more sensors 140 to rotate or otherwise modify itself to capture additional data.

Computing device 102 includes a software engine that may perform other processes such as transferring data in a stream of packets that are interpreted and rendered by a software application as the packets arrive. Device 102 may also include a database or repository, which may be a relational database comprising a Structured Query Language (SQL) database stored in a SQL server. The database may serve data, as well as related information (located in database 104), which may be used by other devices.

Device 102 may include program logic comprising computer source code, scripting language code or interpreted language code that perform various functions of the disclosed embodiments. In one embodiment, the aforementioned program logic may comprise program module 607 in FIG. 6. It should be noted that although FIG. 1 shows only one computing device 120, one refrigeration unit 120 and one pump 130, the system of the disclosed embodiments supports any number of refrigeration units, pumps and computing devices connected via network 106. Also note that although device 102 is shown as a single and independent entity, in one embodiment, server 102 and its functionality can be realized in a centralized fashion in one computer system or in a distributed fashion wherein different elements are spread across several interconnected computer systems.

FIG. 1B is a diagram of the method and system 100 for using pykrete to build and maintain a structure 200, after activation of the system, according to an example embodiment. FIG. 1B shows that the system 100 of FIG. 1A has been activated, which resulted in the pump 130 pumping the mixture from the refrigeration unit 120 (via liquid conduit 133) into the series of pipes of the structure 150 (via liquid conduit 135), and then out of the nozzles 160. Since the refrigeration unit 120 refrigerated the mixture at or near the freezing temperature of the mixture, as the mixture is dispersed form the nozzles 160, the mixture freezes, which results in the roughly spherical pykrete structure 200.

The pykrete structure 200 is strong in compression, as well as strength in tension and bending. Furthermore, the mixture is not heavy or bulky and does not require that it is hauled in large amounts to the location of the structure 200, since the structure may be built on, or near a body of water. This reduces the time and cost involved with building structure 200. Also, the building of structure 200 does not require the use of heavy equipment, since there are no heavy components, such as concrete slabs, used in the building of the structure 200. Further, the building of structure 200 eliminates the necessity for forms made of wood or other material that must be built in place and later retrieved, as is often needed when forming concrete structures. Also, the building of structure 200 does not require the use of special skills or equipment, further adding to the savings in time and cost. Lastly, the structure 200 can be used for the housing of radioactive material in a safe and cost effective way, so as to aid in the prevention of radioactive contamination to the environment, which is explained more fully below.

Recall the system 100 also includes a collection unit 170 for collecting liquid, melted mixture or liquid runoff from the structure 200. The collection unit 170 is located under the structure 200 and acts like a reservoir to catch any melted mixture or liquid from the structure 200, which may occur when the ambient temperature rises above the freezing temperature of the mixture. Recall that the computing device 200 reads data from the one or more sensors 140 to determine the ambient temperature, the size of the walls of the structure 200, and the level of liquid within the collection unit 170, among other things. When activated by the computing device 102, the pump 130 is configured for pumping the liquid in the collection unit 170 (via liquid conduit 137) back into the series of pipes of the structure 150 (via liquid conduit 135), and back to the structure 200.

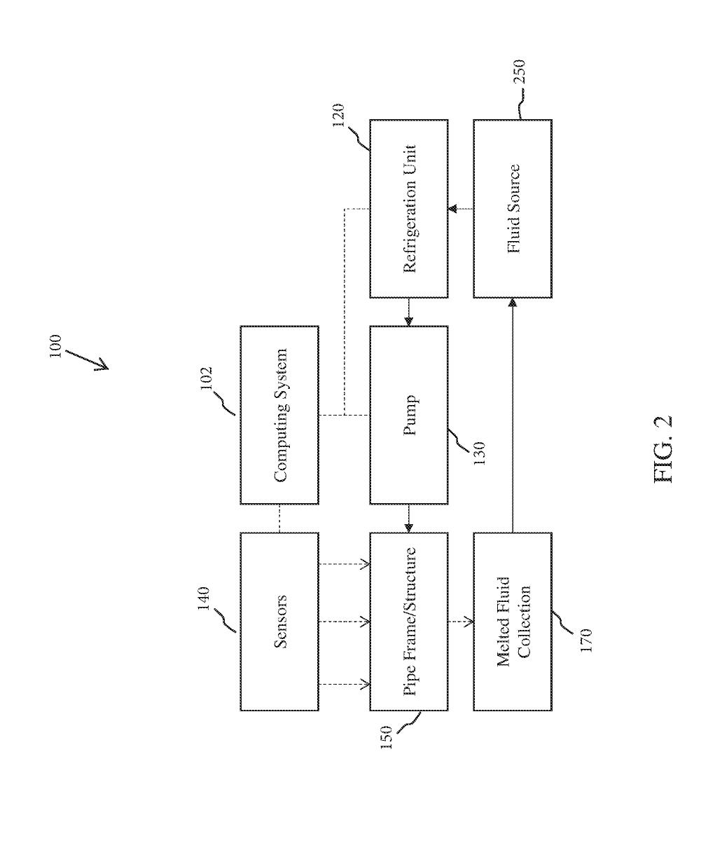

FIG. 2 is a block diagram of the main components of the method and system 100 for using pykrete to build and maintain a structure 200, according to an example embodiment. The system 100 includes a spherical structure 150 comprised of a series of interconnected pipes that include a plurality of nozzles 160 distributed substantially uniformly along the length of the pipes. The system 100 includes a refrigeration unit 120 configured for lowering the temperature of the mixture from a repository or fluid source 250 that holds the mixture. The system 100 also includes a pump 130, which is configured for pumping the mixture from the refrigeration unit 120 (via liquid conduit 133) into the series of pipes of the structure 150 (via liquid conduit 135), and then out of the nozzles 160. The system 100 also includes a collection unit 170 for collecting liquid, melted mixture or liquid runoff from the spherical structure 150. The pump 130 is configured for pumping the liquid in the collection unit 170 (via liquid conduit 137) back into the series of pipes of the structure 150 (via liquid conduit 135). The system 100 may also include one or more sensors 140 for sensing various characteristics of the spherical structure 150 and the collection unit 170. The system 100 may also comprise a computing device or system 102, which may communicate with other devices via a communications network.

The computing device or system 102 is communicatively coupled with the one or more sensors 140, the pump 130, the collection unit 170 and the refrigeration unit 120. The computing device or system 102 receives data from the one or more sensors 140, the pump 130, the collection unit 170 and the refrigeration unit 120. Based on the data it receives from the one or more sensors 140, the pump 130, the collection unit 170 and the refrigeration unit 120, the computing device 102 may send command data to the one or more sensors 140, the pump 130, and the refrigeration unit 120.

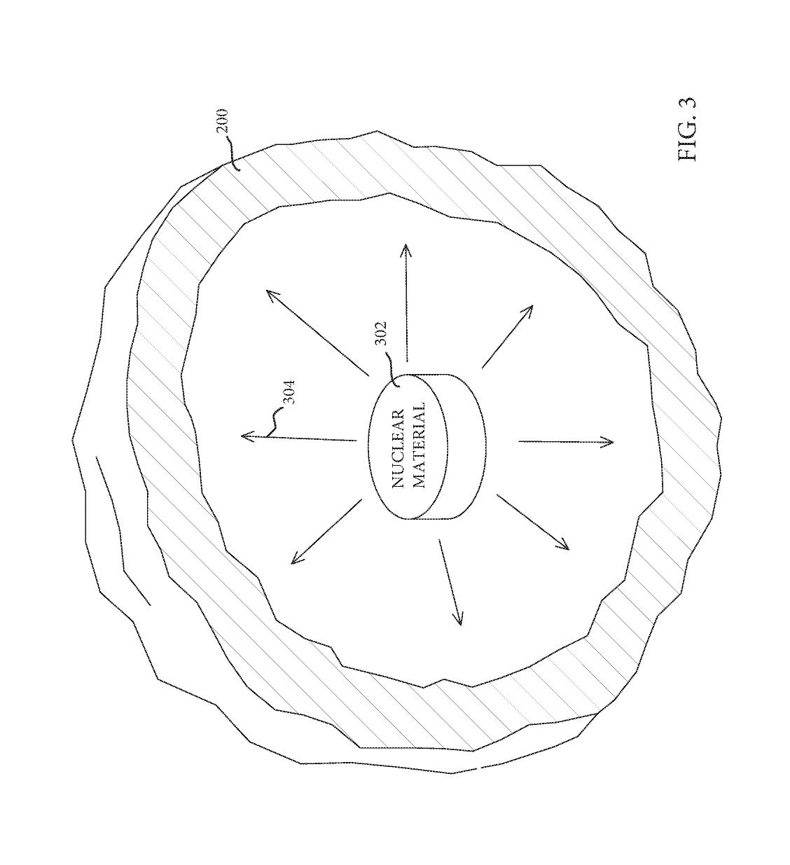

FIG. 3 is a cross-sectional view of one embodiment of the method and system for using pykrete to build and maintain a structure 200, according to an example embodiment. FIG. 3 shows a cross sectional view of the spherical structure 200. FIG. 3 also shows radioactive material 302, which may be in the form of a nuclear reactor, located within the spherical structure 200. The radioactive material may emit various types of radiation, and the spherical structure 200 is configured to provide adequate radioactive shielding to reduce or completely block said radiation from travelling outside of the spherical structure 200. The use of hafnium in the spherical structure 150 results in neutron capture shutting down a nuclear chain reaction. See a more detailed explanation of hafnium below.

FIG. 4 is a drawing of one of the main components of the method and system for using pykrete to build and maintain a structure 200, according to an example embodiment. FIG. 4 shows a cross section of a pipe 402 that is utilized in the spherical structure 150. The pipe comprises a first material 406 that makes up the exterior layer of the pipe. The first material 406 may be aluminum, as it exhibits high compression strength, high tensile strength, high resistance to rust and high resistance to heat. In another embodiment, the first material 406 comprises another metal, such as steel, galvanized metal, copper, or the like.

FIG. 4 also shows that the pipe 402 comprises a second material 404 that makes up the interior layer of the pipe 402. The second material 404 may be hafnium, as it exhibits radioactive shielding capabilities. Hafnium is a shiny, silvery, ductile metal that is corrosion-resistant and chemically similar to zirconium. Hafnium also has a high thermal neutron-capture cross-section and the nuclei of several different hafnium isotopes readily absorb two or more neutrons apiece. Hafnium's large neutron capture cross-section makes it a good material for neutron absorption in control rods in nuclear power plants. Hafnium must be more refined to maximize neutron capture. In another embodiment, the second material 404 comprises another metal, such as zirconium, lead, zinc or the like. In the event of a nuclear reactor malfunction, the hafnium in the aluminum pipes results in neutron capture shutting down a nuclear chain reaction, namely, if the aluminum in the pipes is burned through by the nuclear reactor malfunction and the hafnium is exposed. In another embodiment, the second material 404 comprises a hafnium alloy, such as a hafnium carbide, or a composite material that includes hafnium. With a high melting point—above 4,000 degrees Fahrenheit—hafnium is uniquely suited for high temperature installations.

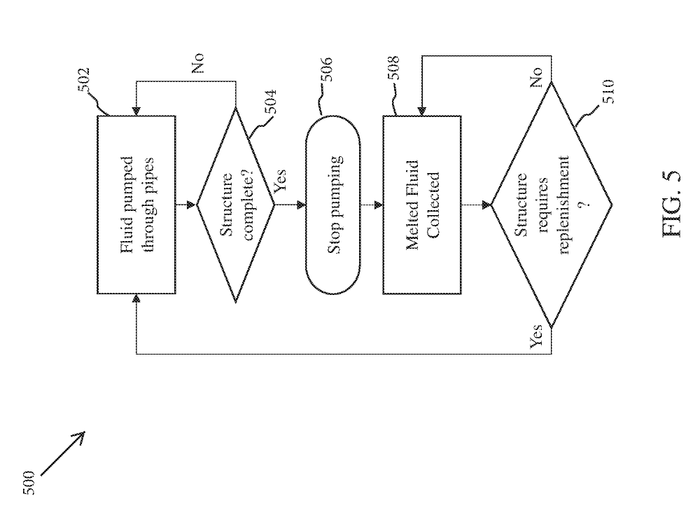

FIG. 5 is a flowchart 500 showing the control flow of the method and system for building and maintaining a solid structure 200 using pykrete, according to an example embodiment. The process of building and maintaining a solid structure begins with step 502 of FIG. 5. In step 502, the refrigeration unit 120 refrigerates mixture from a fluid source 250, and the pump 130 pumps fluid from the refrigeration unit 120 (via fluid conduit 133) to the spherical structure 150 (via fluid conduit 135), and out of the nozzles 160. As the mixture is expelled from the nozzles 160, the mixture freezes into the frozen solid structure 200.

Next, in step 504, the computing device 102 receives data from the sensors 140, the pump 130 and the refrigeration unit 250, and determines whether the solid structure 200 is complete. If the result of the determination of step 504 is negative, then control flows back to step 502, and the pumping of the fluid continues. If the result of the determination of step 504 is positive, then control flows to step 506, and the computing device 102 sends a signal to the pump 130 to stop pumping. Subsequently, pump 130 stops pumping. In step 508, the collection unit 170 collects melted fluid from the structure 200.

Next, in step 510, the computing device 102 receives data from the sensors 140, the pump 130 and the refrigeration unit 250, and determines whether the solid structure 200 requires replenishment. For example, if the sensors detect that the walls of structure 200 are too thin, or if the sensors detect that the temperature of the structure 200 is not within established parameters, then the structure may require replenishment. If the result of the determination of step 510 is negative, then control flows back to step 508, and the collection of the fluid continues. If the result of the determination of step 510 is positive, then control flows back to step 502, and the computing device 102 sends a signal to the pump 130 to start pumping again. Subsequently, pump 130 starts pumping.

As explained above, one of the objects of the claimed subject matter is to be used in connection with a nuclear reactor. To this end, k=1 is a well known equation, where k is the number of neutrons released in each reaction, and when k=1, the reaction is self sustaining. In practice k must be higher to maintain a reaction. The goal of nuclear plant operator is to maintain equilibrium. If the nuclear plant operator allows k go too high, the reactor may become super critical and runs away. Alternatively, if k is too far below 1, the reactor may become sub-critical and the reaction shuts down. The claimed subject matter may be used for active management of k. The claimed subject matter not only shields from radiation, like a block of lead, but actually controls k. The claimed subject matter may be used to remove radiation from a reactor in a process called “siphoning”. The claimed subject matter may be used to restore neutrons to a nuclear reactor system. All nuclear reactors have cooling ponds to keep spent fuel rods. By reintroducing neutrons to a working nuclear reactor, the claimed subject matter may be able to manage k.

All steam-driven energy generation plants, whether be coal or nuclear, have significant energy loss due to inefficiencies when using mechanical energy to drive a turbine. To increase efficiency, the claimed subject matter may be used to raise core temperature or lower atmosphere. Cold water may be circulated (or cease from circulating) via structure 150 to raise or lower temperatures.

FIG. 6 is a block diagram of a system including an example computing device 600 and other computing devices. Consistent with the embodiments described herein, the aforementioned actions performed by device 102 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for device 102 and process 500, as described above. Process 500 may operate in other environments and is not limited to computing device 600.

With reference to FIG. 6, a system consistent with an embodiment may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, and one or more programming modules 606. Operating system 605, for example, may be suitable for controlling computing device 600′s operation. In one embodiment, programming modules 606 may include, for example, a program module 607 for executing the actions of device 102. Furthermore, embodiments may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. Computing device 600 may also include a vibration device capable of initiating a vibration in the device on command, such as a mechanical vibrator or a vibrating alert motor. The aforementioned devices are only examples, and other devices may be added or substituted.

Computing device 600 may also contain a network connection device 615 that may allow device 600 to communicate with other computing devices 618, such as over a network in a distributed computing environment, for example, an intranet or the Internet. Device 615 may be a wired or wireless network interface controller, a network interface card, a network interface device, a network adapter or a LAN adapter. Device 615 allows for a communication connection 616 for communicating with other computing devices 618. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. program module 607) may perform processes including, for example, one or more of the stages of the process 500 as described above. The aforementioned processes are examples, and processing unit 602 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for generating and maintaining a solid structure, the system comprising:
a. a frame composed of an interconnected network of pipes configured for transporting liquid, the frame having a substantially spherical shape;
b. a plurality of nozzles uniformly distributed along the pipes, wherein the plurality of nozzles are configured for dispensing liquid;
c. a repository that holds a liquid composed of water and at least one additive;
d. a refrigeration unit configured for refrigerating the liquid from the repository to at least a freezing temperature; and
e. a pump for pumping the liquid from the refrigeration unit through the pipes and out of the nozzles, wherein the system is configured to dispense the liquid at said freezing temperature so as to freeze upon egress and create a solid structure surrounding the pipes.

2. The system of claim 1, further comprising:
one or more sensors configured for collecting data from the solid structure.

3. The system of claim 2, further comprising:
a computing device communicably coupled with the one or more sensors and the pump, the computing device configured for receiving data from the one or more sensors, determining whether the solid structure requires replenishment and then activating the pump to start pumping the liquid from the refrigeration unit through the pipes and out of the nozzles.

4. The system of claim 3, further comprising:
a collection repository that collects liquid that has melted from the solid structure.

5. The system of claim 4, wherein the collection repository is configured to provide liquid to the refrigeration unit and wherein the pump is configured for pumping the liquid from the collection repository to the refrigeration unit.

6. The system of claim 5, wherein the one or more sensors are further configured for collecting data from the collection repository.

7. The system of claim 6, wherein the computing device communicably is further configured for receiving data from the one or more sensors, determining whether a level of liquid within the collection repository is above a predetermined threshold and then activating the pump to start pumping the liquid from the refrigeration unit through the pipes and out of the nozzles.

8. A system for generating and maintaining a solid structure around a nuclear reactor and for reducing the effects of runaway nuclear reactors, the system comprising:
a. a frame composed of an interconnected network of pipes configured for transporting liquid, wherein the aluminum pipes include an interior coating of hafnium that is refined to maximize neutron capture, the frame having a substantially spherical shape;
b. a plurality of nozzles uniformly distributed along the pipes, wherein the plurality of nozzles are configured for dispensing liquid;
c. a repository that holds a liquid composed of water and at least one additive;
d. a refrigeration unit configured for refrigerating the liquid from the repository to at least a freezing temperature; and
e. a pump for pumping the liquid from the refrigeration unit through the pipes and out of the nozzles, wherein the system is configured to dispense the liquid at said freezing temperature so as to freeze upon egress and create a solid structure surrounding the pipes,
wherein in the event of a nuclear reactor malfunction, the hafnium in the aluminum pipes results in neutron capture shutting down a nuclear chain reaction, namely, if the aluminum in the pipes is burned through by the nuclear reactor malfunction and the hafnium is exposed.

9. The system of claim 8, further comprising:
one or more sensors configured for collecting data from the solid structure.

10. The system of claim 9, further comprising:
a computing device communicably coupled with the one or more sensors and the pump, the computing device configured for receiving data from the one or more sensors, determining whether the solid structure requires replenishment and then activating the pump to start pumping the liquid from the refrigeration unit through the pipes and out of the nozzles.

11. The system of claim 10, further comprising:
a collection repository that collects liquid that has melted from the solid structure.

12. The system of claim 11, wherein the collection repository is configured to provide liquid to the refrigeration unit and wherein the pump is configured for pumping the liquid from the collection repository to the refrigeration unit.

13. The system of claim 12, wherein the one or more sensors are further configured for collecting data from the collection repository.

14. The system of claim 13, wherein the computing device communicably is further configured for receiving data from the one or more sensors, determining whether a level of liquid within the collection repository is above a predetermined threshold and then activating the pump to start pumping the liquid from the refrigeration unit through the pipes and out of the nozzles.
